(19) United States
(12) Patent Application Publication
(10) Pub. No.: US 2006/0041839 A1
(43) Pub. Date: Feb. 23, 2006

(54) System and method for providing formatted print pages

(76) Inventor: Peter Kassan, Dobbs Ferry, NY (US)

Correspondence Address: OSTROLENK FABER GERB & SOFFEN, 1180 AVENUE OF THE AMERICAS, NEW YORK, NY, 100368403, US

(21) Appl. No.: 11/193,716

(22) Filed: Jul. 29, 2005

Related U.S. Application Data
(63) Continuation-in-part of application No. 10/671,194, filed on Sep. 25, 2003.
(60) Provisional application No. 60/460,352, filed on Apr. 3, 2003.
(60) Provisional application No. 60/592,489, filed on Jul. 30, 2004.
(60) Provisional application No. 60/598,985, filed on Aug. 5, 2004.
(60) Provisional application No. 60/604,119, filed on Aug. 24, 2004.
(60) Provisional application No. 60/630,013, filed on Nov. 22, 2004.
(60) Provisional application No. 60/637,652, filed on Dec. 20, 2004.

(51) Int. Cl. G06F 17/00

(52) U.S. Cl. 715/513

(57) ABSTRACT

In one embodiment, the invention regards a method for providing formatted print pages of electronic material in response to a request initiated by a user. The method includes providing to the user a virtual document that includes at least one formatting instruction which affects the appearance of the virtual document. Further, an electronic request is received from the user for the formatted print pages, and the electronic request includes electronic order information, and the formatted print pages are based on the virtual document. The electronic order information is preferably processed to provide electronic production information that represents instructions for fulfilling the request. The electronic production information is preferably transmitted to a fulfillment facility, generating the formatted print pages by the fulfillment facility and providing the formatted print pages to the user from the fulfillment facility.

### CROSS-REFERENCE TO RELATED APPLICATIONS

This patent application is a continuation-in-part of U.S. patent application Ser. No. 10/671,194 filed Sep. 25, 2003 and entitled SYSTEM FOR PRODUCING ONLINE CONTENT FROM WEB SITES ON DEMAND, which claims priority to U.S. Provisional Patent Application Ser. No. 60/460,352, filed on Apr. 3, 2003 and entitled “SYSTEM FOR PRODUCING MAGAZINES FROM WEB SITES ON DEMAND,” and is further based on and claims priority to U.S. Provisional Patent Application Ser. No. 60/592,489, filed on Jul. 30, 2004 and entitled “SYSTEM AND METHOD FOR PRODUCING FORMATTED PRINT PAGES,” and is further based on and claims priority to U.S. Provisional Patent Application Ser. No. 60/598,985, filed on Aug. 5, 2004 and entitled “SYSTEM AND METHOD FOR PRODUCING FORMATTED PRINT PAGES (II),” and is further based on and claims priority to U.S. Provisional Patent Application Ser. No. 60/604,119, filed on Aug. 24, 2004 and entitled, “SYSTEM AND METHOD FOR PRODUCING FORMATTED PRINT PAGES (IV),” and is further based on and claims priority to U.S. Provisional Patent Application Ser. No. 60/630,013, filed Nov. 22, 2004 and entitled “SYSTEM AND METHOD FOR PRODUCING FORMATTED PRING PAGES (V),” and is further based on and claims priority to U.S. Provisional Patent Application Ser. No. 60/637,652, filed Dec. 20, 2004 and entitled “SYSTEM AND METHOD FOR PRODUCING FORMATTED PRING PAGES (VII),” the entire contents of all of which are hereby incorporated herein by reference.

### BACKGROUND OF THE INVENTION

1. Field of the Invention

The present invention relates, generally, to providing formatted print pages and, more particularly, to providing improvements in the way formatted print pages are ordered, processed and delivered.

2. Description of the Related Art

Computer software programs are known that enable electronic document exchange. For example, ADOBE SYSTEMS INCORPORATED provides software that provides “a reliable format for electronic document exchange that preserves document integrity so files can be viewed and printed on a variety of platforms” (http://www.adobe.com/products/acrobat/main.html). Software applications such as ADOBE ACROBAT are used to create an electronic file that is copied and converted from an original file. The original file, typically, originates in a different format, such as MICROSOFT WORD (DOC), the Tagged Image File Format (TIFF), Graphics Interchange Format (GIF), Joint Photographic Experts Group format (JPEG), or the like.

ADOBE ACROBAT, in particular, provides electronic files in the Portable Document Format (“PDF”) which can be viewed using the ADOBE ACROBAT READER. Moreover, PDF files are viewable in common web browser software applications, such as MICROSOFT INTERNET EXPLORER, once ADOBE ACROBAT READER is installed on a user's computer system. Thus, ACROBAT READER is operable as a stand-alone product (for accessing a PDF file), and/or operates as a plug-in to web browser software such that the PDF viewer operates “inside” the web browser application.

Various kinds of electronic files are available that contain various kinds of formatting. For example, word processing files such as created in MICROSOFT WORD, MICROSOFT WORKS, and WORDPERFECT, and spreadsheet files such as those created in MICROSOFT EXCEL (often used to create forms) contain formatting codes and commands that affect page appearance, as well as the appearance of text, numbers, images, and other elements in a file. Various software applications, such as MACROMEDIA FLASH, MICROSOFT WORD, MICROSOFT WORKS, WORDPERFECT, and MICROSOFT EXCEL operate either as stand alone applications or as plug-ins to web browser software applications to enable electronic files to be displayed (or otherwise used).

With the advent of ACROBAT READER and other popular software applications that provide electronic files in well-known formats, electronic files can be displayed in and downloaded to various computing devices (e.g., personal computers, portable digital assistants (PDAs), cell phones, or the like) around the world. Moreover, software applications, such as word processors (e.g., MICROSOFT WORD), desktop publishing programs (e.g., QUARK EXPRESS and IN DESIGN), and presentation software (e.g., MICROSOFT POWERPOINT) can be used to create an electronic file, which can be used to display the file in its “native” format, or, alternatively, to convert the electronic file to another format, for example PDF.

As used herein, the term “virtual document,” refers generally, to a file that, when processed by appropriate software running on an appropriate device, is displayed on a display device in a way that suggests, imitates, simulates, or emulates the appearance of a real, physical document. Also as used herein, a “virtual document” is not the file itself but a display of a file. Virtual documents include, for example, word processing documents, spreadsheet files, digital images and the like.

Referring to the drawings in which like reference numerals refer to like elements, FIG. 1 shows an example web browser display screen 100 that illustrates a PDF file available on the United States Copyright Office Internet web site (http://www.copyright.gov/legislation/dmca.pdf). In the example shown in FIG. 1, ACROBAT READER has been installed and operates as a plug-in to a web browser software application. In the example as shown in FIG. 1, the PDF file was originally created in a word processing document such as MICROSOFT WORD, and then converted into PDF format using ADOBE ACROBAT and displayed in the web browser display screen is formatted to give the same appearance as the original file from which it was created (i.e., the Digital Millennium Copyright Act of 1998). More particularly, the PDF in FIG. 1 includes a graphic symbol, a bulleted list, and footnotes that are provided in the original document. Thus, and as illustrated in FIG. 1, virtual document including PDF files, appear to recreate formatted print pages.

Unfortunately, printing virtual documents, especially those that comprise art, graphics or photography, for example, on a home printer usually yields unsatisfactory results for various reasons. For example, and as described in pending U.S. patent application Ser. No. 10/671,194, many printing devices do not accommodate double-sided printing. Although some printing devices have double-sided capability, users often forget or do not know how to set their printing devices to take advantage thereof. Further, some printing devices, for example, many kinds of laser printers, do not print in color. Also, optimal results for art, graphics and photography are only achieved by using special and typically expensive paper. Moreover, most photo-quality paper is not distributed having a double-sided capacity. Also, even if a user has the appropriate device, paper, and skills to format and print virtual documents such that they are well laid-out on both sides of a set of pages of appropriate quality, the print jobs are typically output on unbound single sheets of paper and are also, therefore, unsatisfactory. Even typical home printers that are capable of printing on both sides of double-sized paper (and therefore would theoretically permit the user to create a conventional bound, printed document) do not include any capabilities for folding the pages or binding at the fold, so make the creation of such finished documents impractical if not impossible for home users.

Thus, even though a typical prior art virtual document (e.g., a PDF file) may appear to be formatted to closely resemble an original file and/or formatted print pages, a printed copy of the virtual document typically suffers from various defects, such as described above and in pending U.S. patent application Ser. No. 10/671,194.

As used herein, “formatted print pages” refer, generally, to pages that comprise text, graphics and/or images that are printed on a particular paper size, in a particular format and layout, using specific colors or print technology such that sequential pages can be placed on one side of sequential printed pages or, preferably, in a double-sided arrangement. Typically, the resolution of formatted print pages is 70 times higher than that displayed in typical web pages. Formatted print pages have a much more attractive, professional form and appearance over prior art forms, substantially as described above. In accordance with the present invention, formatted print pages are derived from virtual documents, regardless of the source of the virtual document.

A number of the web sites owned and/or operated by companies, organizations, and specialized vendors offer various kinds of virtual documents. These are known in the art, generally, as “e-books” and “e-docs” (for “electronic books” and “electronic documents,” respectively). As used herein, the term “e-doc” is used to refer to virtual documents, including e-books, e-docs and related electronic materials. Using appropriate software referred to herein, generally, as an “e-book reader,” e-docs are readable on such devices as personal computers, PDAs, cellular telephones, or the like. Example of e-book readers can include ADOBE ACROBAT, ADOBE READER, MICROSOFT READER, or, in some cases, simply an Internet Web browser such as MICROSOFT INTERNET EXPLORER. Moreover, some e-docs are provided as word processing documents and are displayable in a word processor such as MICROSOFT WORD. At one time, electronic devices designed specifically for reading e-docs were available. These were not commercially successful, however, and most (if not all) have disappeared from the marketplace.

In a typical scenario, e-docs are available to be viewed for free or for the payment of a fee (that is, for sale in the same sense that a physical book or booklet is for sale). When a user selects or purchases an e-doc, an appropriate digital file is typically provided. For example, the digital file is downloaded via the Internet to the user's computer (or other electronic device) and thereby is made available for viewing via appropriate software, such as described above.

E-docs provide a number of apparent benefits to writers, publishers, and other entities, because e-books allow such publications to be made available to the public without the usual expense and economic risk of physically printing physical copies of the e-doc with the hope that the copies will be sold or otherwise distributed. Notwithstanding this apparent benefit, printed output of e-docs suffer from many of the defects and deficiencies described above, and most people do not find them as convenient and desirable as conventionally printed and bound documents.

Even though e-docs may appear on a computing device's display to be like formatted print pages (e.g., a printed book), there are significant differences between e-docs and formatted print pages, (such as a conventional printed document that is, for example, double-sided and bound). Formatted print pages, generally, cannot be printed from e-docs directly. These and other shortcomings of printing e-docs are described in greater detail below.

One typical shortcoming associated with printing e-docs is that the pages appear in the wrong order for printing on double-sized paper for later folding and binding, even though an e-book reader presents the pages one at a time, in serial order, as is necessary for reading. Many e-book readers also provide indexing and tabs that allow the user to jump to a particular location, but the pages are still arranged in a sequential order. Accordingly, in order to prepare a document for printing and binding, the pages must be completely rearranged. This process is known in the art as “imposing” or “imposition,” and is described in greater detail in co-pending U.S. patent application Ser. No. 10/671,194, of which the present patent application is a continuation-in-part.

Another shortcoming associated with e-books is that the difference between right-hand and left-hand pages is not respected or correlated with the page numbering. For example, odd-numbered pages are typically right-hand pages and, correspondingly, even-numbered pages are typically left-hand pages. Page numbers and other reference information appear on or near the outside corner of the printed page. Although an e-doc may arranged so that odd- and even-numbered pages have an appropriate arrangement, “page 1” may immediately follow the cover page, so that the second apparent page—what would normally be a left-hand page—is meant to be seen as a right-hand page. Before such a document could even be imposed, it would be necessary to insert a page between the cover page and the so-called “page 1”—what in a physical book or booklet is known as the “inside front cover”.

Moreover, major sections, such as a table of contents, individual chapters, parts, and respective sections of back-matter (such as notes, references, bibliography, appendixes, and indices) traditionally begin on a right-hand page, so that additional pages may have to be inserted immediately preceding the sections. E-books do not account for such traditional layout requirements.

Another shortcoming associated with e-books regards major divisions, such as parts that are typically announced on a right-hand page whose overleaf (the left-hand page when the page is turned) is typically blank, so additional pages may have to be inserted both before and after the page announcing each such major division. Also, because e-doc readers provide a variety of means for accessing sections within a document, such sections, perhaps including the table of contents, may be in an inappropriate location, and that page or those pages may have to be moved.

Another shortcoming associated with printing e-docs is that the number of pages may not be appropriate. Since, when a document is printed double-sided, folded, and bound, each physical sheet of paper contains four physical page images (some possibly largely or completely blank), the number of pages must be a multiple of four. E-docs are created without regard to this requirement. When, after all the appropriate pages have been inserted or moved, the number of pages is not a multiple of four, additional extra pages must be added, typically at the end of the document but before what is intended to be the back cover. Traditionally, a back cover is included after the last page of content, although this is often omitted in e-docs. In such a case, a back cover must be created as the last page after all appropriate pages have been added or rearranged.

Another issue with respect to printing e-books is that the e-doc may be designed for a reader of a size inappropriate for a physically printed page. This is typically true of e-docs designed to be read on PDAs. In this case, the entire document may have to be redesigned and repaginated. The e-doc may show a page-image of a size other than a standard printing paper size. In order to provide a printed version of such an e-doc, printers usually need an indication known in the art as “trim marks” or “crop marks”) printed on each page. The e-doc does not typically provide such marks.

Furthermore, the e-doc may display pages with color at one or more edges. In order to provide a printed version of such an e-doc, most printers need to print on pages larger than the intended size, as well as trim marks or crop marks. Furthermore, in order to accommodate the slight variability inherent in the trimming processing, the color at the edge of a page must be extended slightly past the intended edge of the page, typically by a minimum of one-tenth of an inch (although more is preferable if the paper size permits it). In an e-doc, the color at the edge of a page cannot do this, since the page in a virtual document doesn't extend beyond its own borders.

Another problem associated with printing e-docs is that pages that refer to online facilities or that include help descriptions embedded in the text of the e-docs are printed. This is typically undesirable because such pages contain content that is particular to the electronic version of the document.

Moreover, the type size of a e-doc may not be fixed (that is, may be under the control of the user of the e-doc viewer), so that the layout of the e-doc, when printed, is not fixed. Pages may have to be added, right and left pages may not be properly aligned (for example, caused by placement and format of headers and/or footers), and the actual number of pages that are to be included may be unknown. Furthermore, any text that is formatted as a hyperlink needs to be eliminated and/or re-entered, or formatted properly, since the equivalent in a printed document to a hyperlink in a virtual document is a cross-reference, which typically gives the title and the page number of the referenced section or material. Also, various controls that are provided in software applications, such as buttons, icons, or other graphic screen controls, including text-to-speech toolbars, drop-down navigation lists or other tools, may need to be eliminated. Also, headers and/or footers are typically centered in e-docs. In order to more closely resemble a printed book, headers and footers may need to be adjusted for far left/right hand printing including, for example, page numbers, chapter numbers and the title of the book.

In addition, some e-docs may not be presented in page-image format at all, but may consist simply of one or more sections of text of variable length longer than can be seen at one time on the intended viewer. In this case, the user is expected to scroll through the text one or several lines at a time, or “jump” from one body of viewable text to the next, as-yet-unread portion, without regard to the simulation of physical pages. When the user “jumps” from one screenload to the next, one or more lines of text from the end of the previous screenload are typically repeated at the top of the next screenload, so that the user is not disoriented as he reads. Ironically, this jumping is known as “paging.”

Even if it turns out that no such adjustments happen to be necessary in a particular case before that particular e-book can be imposed, each e-doc must be reviewed to see whether any such adjustment is necessary. Only after it is confirmed that an e-doc is appropriately arranged can it be imposed properly. However, because there is often no physically printed version of the e-doc and no such printed version is anticipated, this preparation is typically not done for e-docs, and no electronic version of the e-doc suitable for bound, double-sided printing exists. Therefore, there is no convenient way for an on-demand printed version of an e-doc to be offered.

In case electronic content has any color and the intended use is for viewing on-line (as in an e-book or an e-doc), the color is almost certainly formatted in red, green and blue (“RGB”), which is the color format used for display devices. In order to produce formatted print pages, the content formatted in RGB must be converted to cyan, magenta, yellow and black (“CMYK”) format, which is the color system used for printing. Unfortunately, software applications that are often provided with color printers, for example, ink jet printers, do not accurately convert RGB format to CMYK. Also, if the content has any color and is intended for conventional printing (e.g., a detailed brochure), the content may include “spot” color, known in the art, typically, as a color produced by a particular ink specified using a color-matching system such as PANTONE. Spot colors also have to be converted to CMYK if they are to be printed laser or inkjet printers.

Furthermore, in the case that the electronic content has any graphic images such as photographs, artwork, diagrams, and the like, those graphic images are typically at a resolution suitable for display on a computer screen (typically 70 to 72 dots per inch) and not suitable for printing (which typically requires a minimum of about 150 dots per inch for satisfactory results).

Moreover, a virtual document may make use of fonts (and/or typefaces) that are available on a particular computer system, but may not be part of the virtual document at all. Without the appropriate treatment of the fonts (typefaces), the document may not print properly. In other words, the fonts may have to be embedded in the electronic file prior to printing formatted print pages.

It is envisioned herein that a home version of a printer is or will, eventually, be available to perform all or at least many of the things that large-scale commercial digital printers can, such as described in pending patent application Ser. No. 10/671,194, and included in the present invention. For example, consumer printers are or will be available, for example, to produce bound, folded, double-sided magazine-like material.

In the prior art, the ability to offer bound, printed versions of material on an Internet web site, as well as material provided in other locations/ways, is not made readily available. In many cases, although individuals associated with an Internet web site may be technically capable of producing print-ready, electronic versions of the material, they may otherwise wish to make available via the web site on an on-demand basis. Unfortunately, providing such on-demand print-ready versions is cost-prohibitive.

Furthermore, a great many printing companies have equipment capable of producing bound, printed versions of formatted print pages on an on-demand basis. However, although such printing companies may have taken steps to make their capabilities known to potential users, the establishment of a relationship between web sites and printing companies is not made because each job must be estimated and bid separately, and the communication of the individual orders from the web site to the printing company has not been conveniently established. Thus, the relationship between web sites and printing companies is not straightforward and/or established.

Moreover, many people have a need or desire for a formatted, printed hard copy of electronic content they view over a communication network, such as the Internet. As described in co-pending U.S. patent application Ser. No. 10/671,194, for example, a person operates Internet web browser software to “visit” an Internet web site, and orders a printed and bound copy of content the visitor selects. The invention includes modules that operate to take, process and complete the order, such that the visitor receives (e.g., by mail) formatted print pages of the content he selected. In addition to a need for formatted print pages of content stored on Internet web sites, there is a need for formatted print pages of content provided in many other electronic contexts.

### SUMMARY OF THE INVENTION

The present invention recognizes and provides solutions to the above-identified problems and needs regarding formatted print pages.

In one embodiment, the invention regards a method for providing formatted print pages of electronic material in response to a request initiated by a user. The method includes providing to the user a virtual document that includes at least one formatting instruction which affects the appearance of the virtual document. Further, an electronic request is received from the user for the formatted print pages, and the electronic request includes electronic order information, and the formatted print pages are based on the virtual document. The electronic order information is preferably processed to provide electronic production information that represents instructions for fulfilling the request. The electronic production information is preferably transmitted to a fulfillment facility, generating the formatted print pages by the fulfillment facility and providing the formatted print pages to the user from the fulfillment facility.

In another embodiment, the present invention regards a method for providing electronic information suitable for generating formatted print pages of electronic material in response to a request initiated by a user. The method comprises providing to the user a virtual document that includes at least one formatting instruction that affects the appearance of the virtual document. An identifier of a printing device is received from the user, as is an electronic request for the formatted print pages. Preferably, the electronic request includes electronic order information, and the formatted print pages are based on the virtual document. The electronic order information is processed to provide electronic production information representing instructions for fulfilling the request, and the electronic production information is transmitted to the user. The user generates the formatted print pages as a function of the transmitted electronic production information.

Other features and advantages of the present invention will become apparent from the following description of the invention which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example web browser display screen that illustrates a PDF file available on an Internet web site;

FIG. 2A shows an example display screen 200 representing an embodiment of the present invention;

FIG. 2B shows another example display screen 200 representing an embodiment of the present invention;

FIG. 3 illustrates an example display screen that is provided to a user after a request for formatted print pages is made;

FIG. 4 shows an Internet web site in accordance with the present invention in which a column provides controls corresponding for ordering formatted print pages for respective e-docs;

FIG. 5 is a flow chart that identifies steps associated with ordering formatted print pages in accordance with a preferred embodiment of the present invention;

FIG. 6 is a flow chart that illustrates steps associated with producing formatted print pages for a consumer printer; and

FIG. 7 illustrates an example interface that is preferably provided by the present invention when a user requests formatted print pages of content available in one or more Internet web sites.

### DETAILED DESCRIPTION OF EMBODIMENTS OF THE INVENTION

The present invention preferably enables users who wish to have formatted print pages provided from one or more virtual documents to do so in a way that is both economical and convenient. A user of a software application that displays a virtual document can request a printed version of a virtual document, for example, to be formatted as a magazine and, thereafter, to be printed double-sided, stapled and/or otherwise bound, folded and, if necessary, trimmed to an appropriate size, simply by selecting a control in the software application.

In a preferred embodiment of the present invention, the control is formatted as a graphic screen control that is intuitive to use, such as a button or icon, and is easily selectable by a user. When a user selects the control, the user provides information, for example, in a data entry form. In an alternative embodiment, information is provided once by a user, and the information is stored and retrieved automatically to fulfill a request for formatted print pages.

The present invention preferably provides formatted print pages from virtual documents in response to an electronic request. The electronic request may be generated on a device and, thereafter, transmitted and received over a communication network. Alternatively, the request may be made over a communication network. Preferably, the invention includes software that operates in conjunction with substantially any suitable software application that displays, offers for viewing or for sale, provides link to, and/or allows the user to select virtual documents in order to enable a user to submit a request for formatted print pages. Alternatively, a software application that displays virtual documents includes the features described herein.

As used herein, a “system user” refers, generally, to a person, typically associated with the web site itself, who, using the portion of the invention providing a visual, interactive interface, provides certain specifications as to how pages can be printed and how the bound, printed version can be formatted, produced, or the like. The “web site visitor” is someone who, in the context of the Internet, uses an Internet browser and the Internet to display the web site and request the bound, printed version of the web pages displayed. The web site visitor is sometimes also referred to simply as the “visitor”.

Also as used herein, the term “web page” is used to refer to an element of the web site displayed via an Internet browser. The term “printed page” refers to a page in the bound, printed document produced by the system.

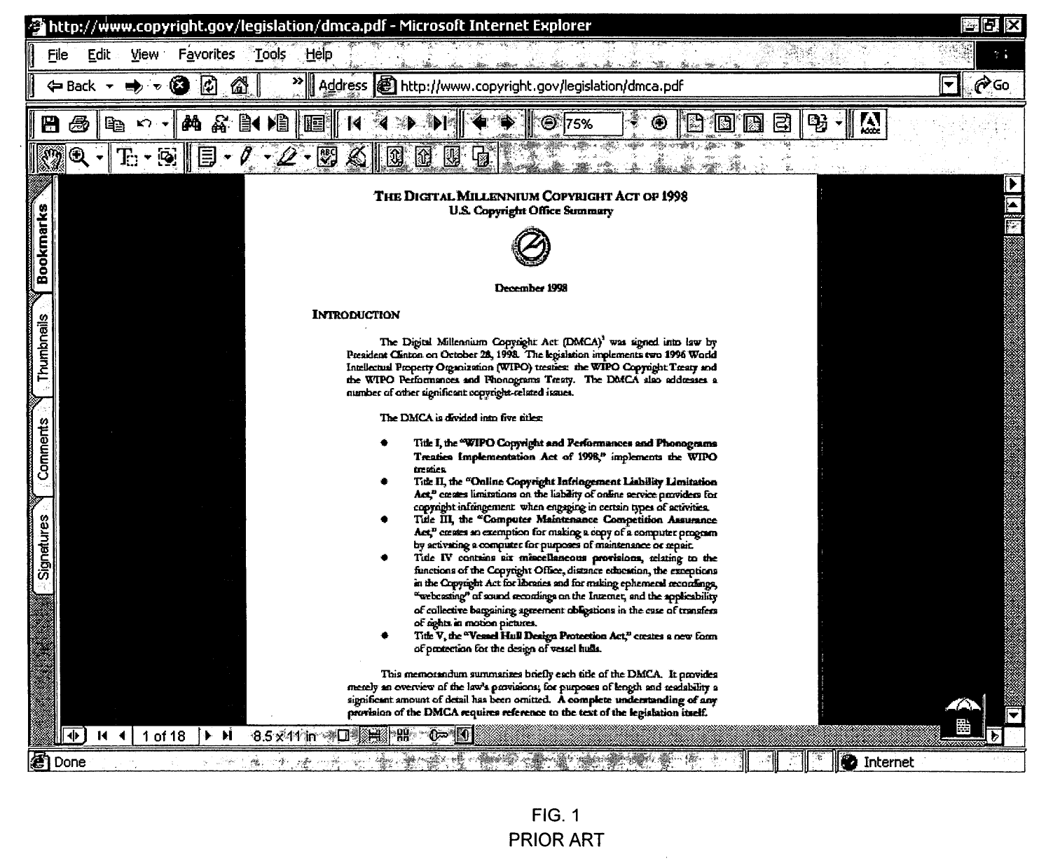

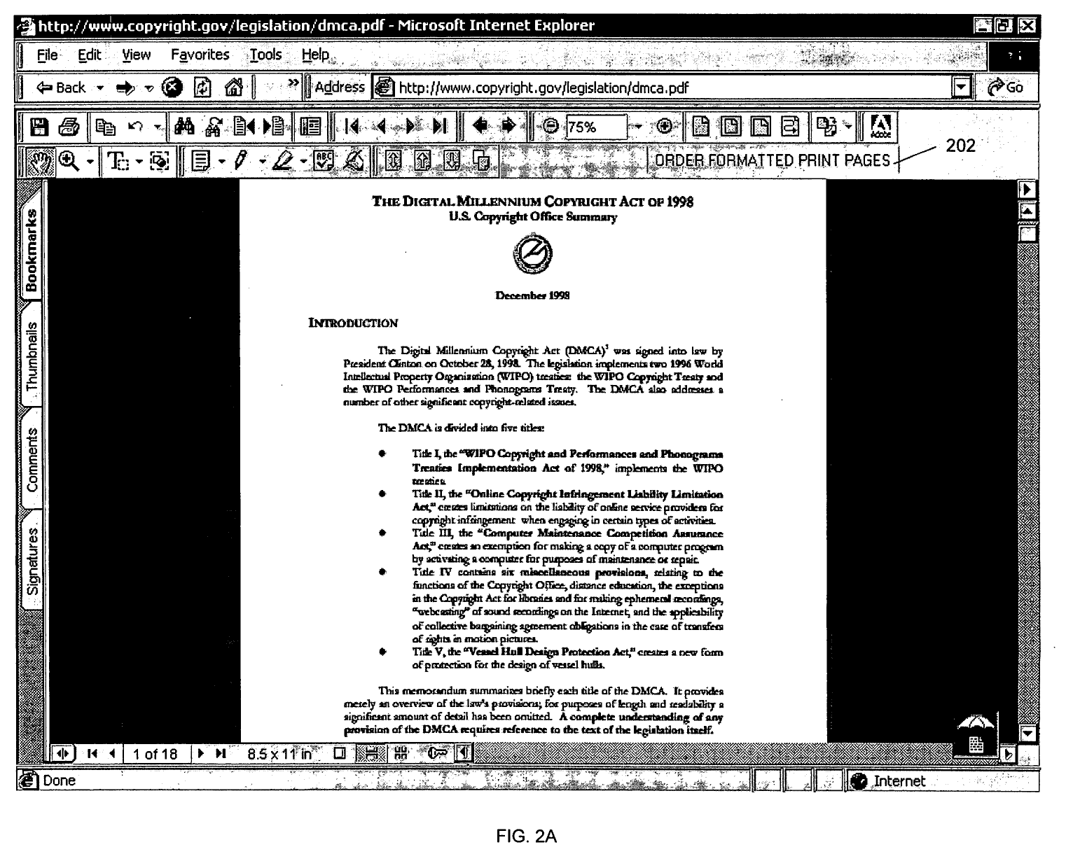

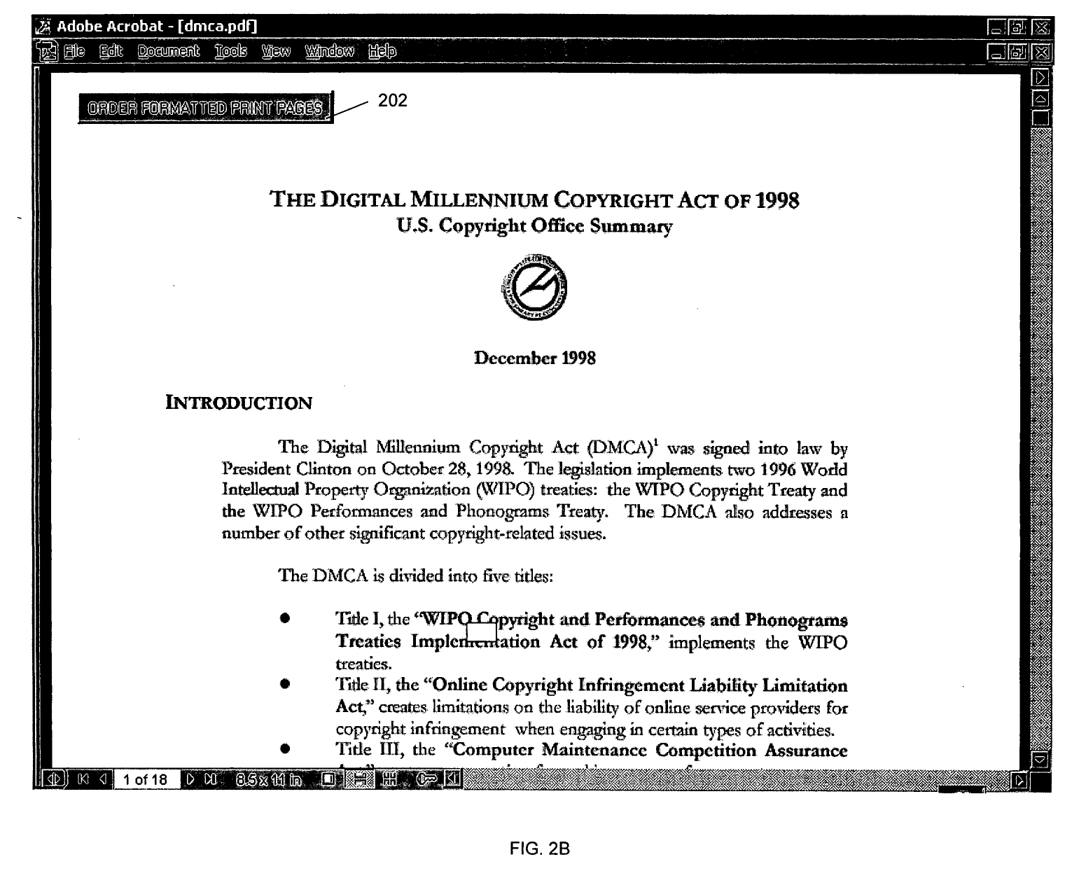

FIG. 2A shows an example display screen 200 representing an embodiment of the present invention. The example display screen in FIG. 2A resembles the prior art example shown in FIG. 1, however includes control 202 which, when selected, allows a user to request formatted print pages, as described above. In the example shown in FIG. 2A, control 202 is formatted to read “Order Formatted Print Pages.”

FIG. 2B shows another example display screen 200 representing an embodiment of the present invention. The example display screen 200 shown in FIG. 2B illustrates graphic screen control 202 which, when selected, allows a user to request formatted print pages, as described above. In the example shown in FIG. 2B, control 202 is installed in ACROBAT READER, and is formatted as a button. Of course, one of ordinary skill in the art will recognize that control 202 can be formatted in many different ways, including, for example, as an icon, textual hyperlink, or the like. Although the example shown in FIG. 2 illustrates ACROBAT READER functioning as a plug-in to web browser software, the invention is not so limited. The present invention supports adding graphic screen control 202 to substantially any suitable computer software application capable of displaying or providing a virtual document. Thus, for example, the present invention can be used in popular software applications such as desktop publishing programs (e.g., QUARK EXPRESS and IN DESIGN), presentation applications (e.g., MICROSOFT POWERPOINT), word processor applications (MICROSOFT WORD or WORDPERFECT) and spreadsheet applications (MICROSOFT EXCEL).

Preferably, the present invention includes receiving electronic order information representing a request for formatted print pages and processing electronic order information to provide electronic production information representing instructions for fulfilling the request. The invention further includes transmitting the electronic production information to a fulfillment facility and providing to the visitor the requested information from the fulfillment facility in the form of formatted printed pages, substantially as described in co-pending U.S. patent application Ser. No. 10/671,194, of which the present application is a continuation-in-part.

In accordance with the present invention, a screen control, such as a menu command, icon, button or other graphic screen control is provided to allow a user to request formatted print pages in a software application that provides virtual documents. In a preferred embodiment, the graphic screen control, when selected, invokes commands to display a data entry form, such as a windowed dialog box, in order to provide details such as name, address, payment information or the like to be collected from the user. Preferably, at least some of the information is required and a request for formatted print pages cannot be processed unless the required information is submitted.

After the user submits at least the required information, the user preferably selects another graphic screen control in the windowed dialog box, such as a button labeled OK, to issue one or more commands to transmit the information collected in the data entry form and place an order for formatted print pages. The information is transmitted electronically, via the Internet or other communication network, to a production information processor, such as described in pending U.S. patent application Ser. No. 10/671,194.

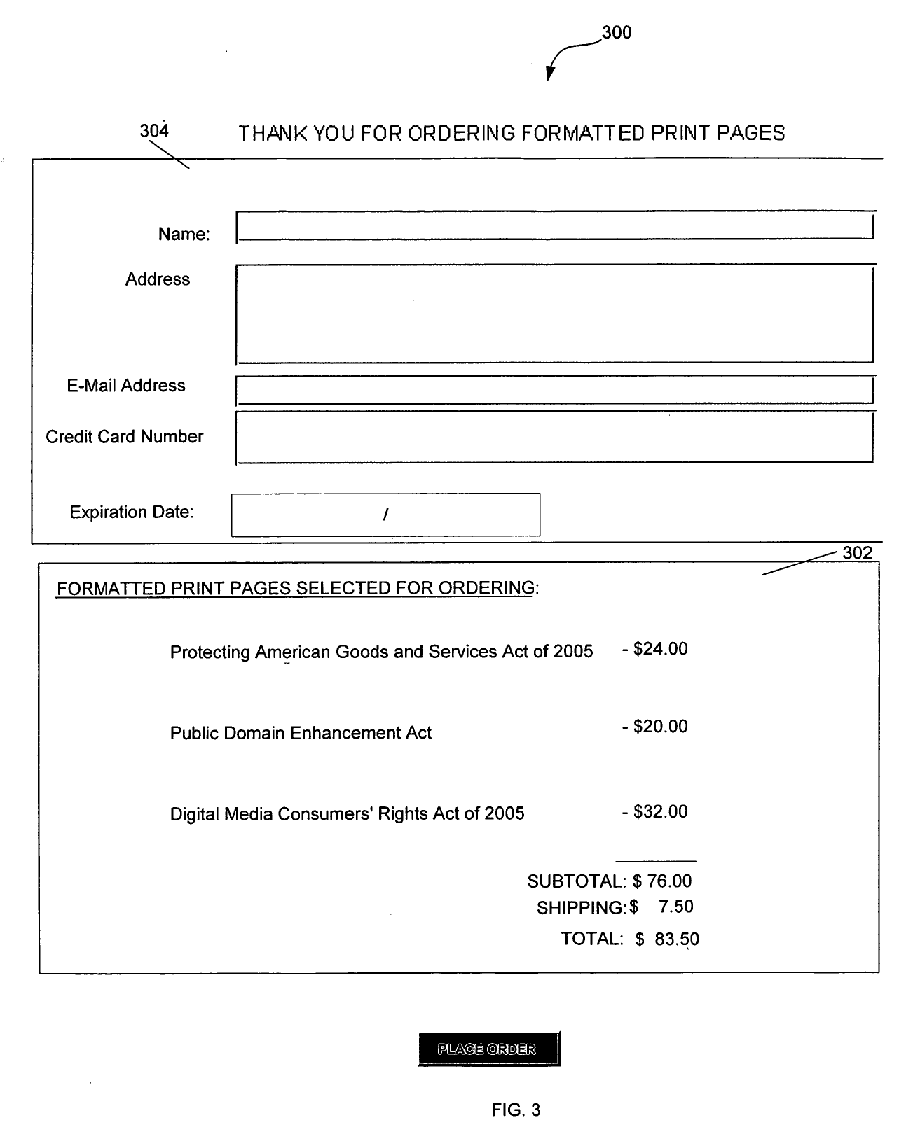

FIG. 3 illustrates an example display screen 300 that is provided to a user after graphic screen control 202 is selected (FIGS. 2A and 2B). As shown in FIG. 3, prompt 302 is preferably presented that indicates the virtual documents the user wishes to have printed, as well as the prices associated therewith. Further, data entry section 304 is preferably provided for receiving demographic and payment information. Of course, one skilled in the art will recognize that the example display screen 300 is illustrative of an embodiment of the present invention, and that many ways of providing an indication for ordering formatted print pages in accordance with the present invention are possible.

Thus, whether the user is provided a virtual document in a software application that supports e-documents, including for example, a web browser display screen and/or an e-document reader application, the user preferably selects a control such as a button to request delivery of formatted print pages. For example, a user may have written a file using MICROSOFT WORD. In accordance with an embodiment of the present invention, MICROSOFT WORD includes control 202 to enable a user to order formatted print pages of the virtual document (the .DOC file).

In an alternative embodiment, in the case where a web site provides one or more hyperlinks to virtual document(s) but does not display the virtual document(s), the web site includes graphic control(s) 202, as described above, to enable a user to order formatted print pages corresponding to one or more virtual documents.

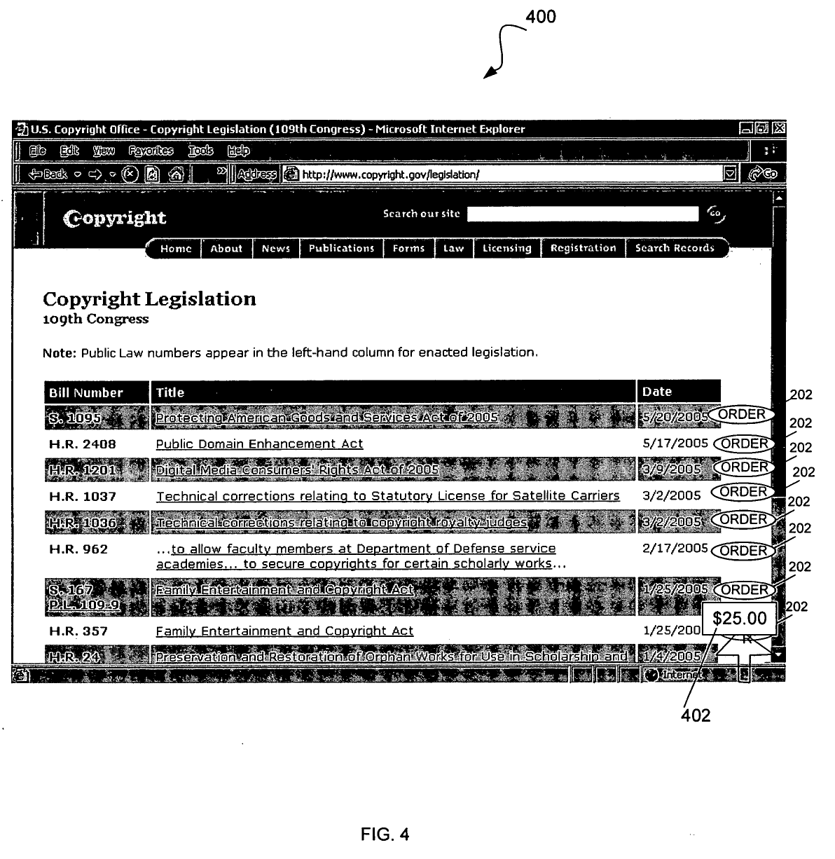

FIG. 4 shows a display screen 400 of a web site in accordance with the present invention in which an additional column has been added to provide controls 202 corresponding with each respective virtual document hyperlink. Thus, for example, by clicking on icon 202 that is adjacent to the hyperlink for the Public Domain Enhancement Act, the user can order formatted print pages of the Public Domain Enhancement Act. Also, as shown in FIG. 4 and in a preferred embodiment, price 402 of the formatted print pages is displayed for the user. In the example shown in FIG. 4, the price is displayed when the user moves his selector device (e.g., mouse pointer) over icon 202. Of course, one skilled in the art will recognize that the price of the formatted print pages can be displayed in any suitable way or place in the display.

The present invention is operable to take and/or receive orders for formatted print pages in virtually any software application that can display and/or print virtual documents. In one embodiment, ordering information and payment information can be collected by a web site itself, and the web site can transmit the order information to a processing center for fulfillment. In an alternative embodiment, a request for formatted print pages of a virtual document invokes a facility controlled by a processing center, which is operable to collect information and payment from a user, as well as to handle the fulfillment of the formatted print page request.

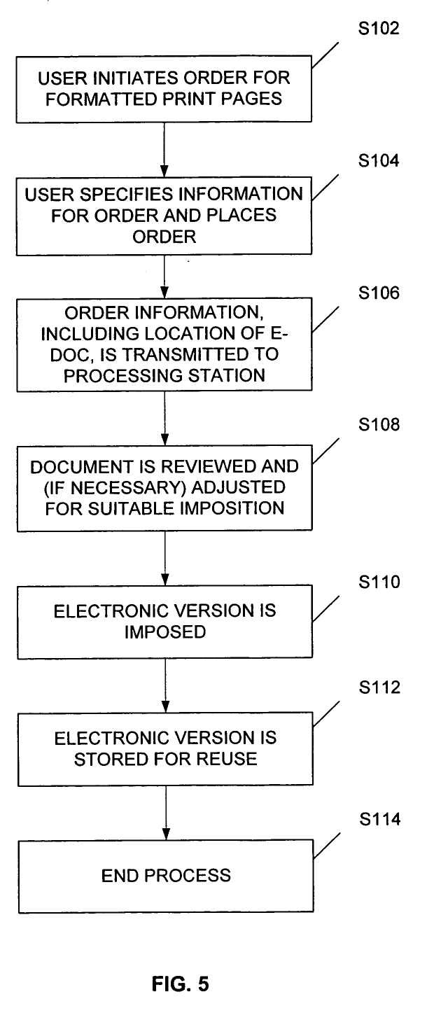

Other features of the present invention are described below with reference to the flow chart shown in FIG. 5.

At step S102, a web site visitor initiates a request for a printed, for example, bound copy of an e-doc. In an alternative embodiment, and in anticipation of an order, the e-doc or its location (along with the appropriate ordering information, if any) is made available to the processing station. For example, when a party makes an e-doc available (e.g., over a communication network), the party alerts a processing station of the location of the e-doc. After the user initiates the order (e.g., by selecting graphic control 202), the user specifies order information and places the order (S104). Thereafter, in step S106, the ordering information is transmitted to a processing station.

At the processing station, via manual, semi-automatic, or wholly automatic means (that is, with or without the intervention or review of a human operator), the e-doc is reviewed for all the formatting considerations necessary, as discussed above.

Using appropriate software, via manual, semi-automatic, or wholly automatic means (that is, with or without the intervention or review of a human operator), adjustments to the electronic version of the document, as discussed above, are made as appropriate and necessary to prepare a version suitable for imposition (S108).

Thereafter, and preferably using the appropriate software, the electronic version is imposed (S110). If appropriate, and at any convenient stage in the preparation process, page size, trim marks, and other control information is added to the electronic version. If an actual order has been received, it is fulfilled as discussed in the prior disclosures. Thereafter, the electronic version suitable for printing is stored for reuse (S112). Thereafter, the process ends at step S114.

Thus, the present invention provides a new way to provide formatted print pages comprising content from virtual documents.

As noted above, it is envisioned herein that a home version of a printer is or will be available at some point in the future to perform all or at least most of the things that large-scale commercial digital printers can, such as described in pending patent application Ser. No. 10/671,194 and included in the present invention. For example, consumer printers are or will be available, for example, to produce bound, folded, double-sided magazine-like material.

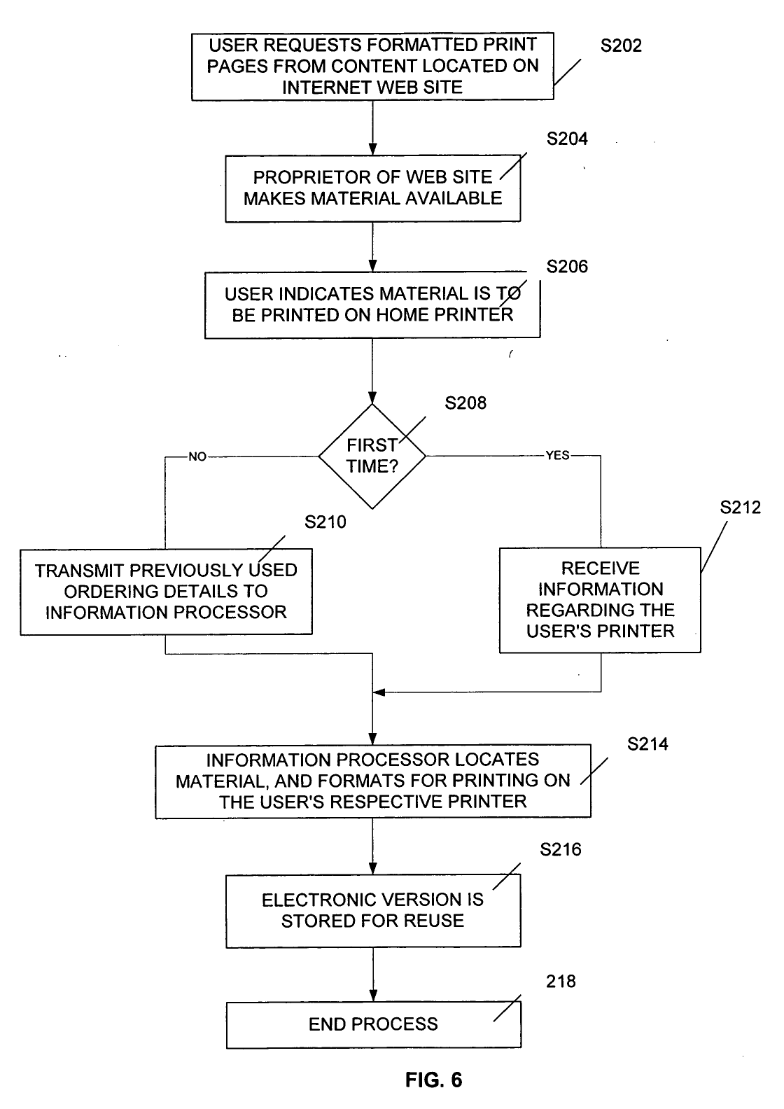

In accordance with the present invention steps associated with producing formatted print pages for a consumer printer capable of producing formats, as described above, are described with reference to FIG. 6.

FIG. 6 is a flow chart that includes steps associated with providing an electronic file capable of producing formatted print pages on a consumer printer. In step S202, a communication-based process establishes a communication session between a user's workstation (e.g., personal computer) and an information processor. The information processor preferably performs steps associated with managing electronic content, such as described in co-pending U.S. patent application Ser. No. 10/671,194. In the current example, the workstation is communicating with an Internet web site, and the web site provides content to be included in formatted print pages. In an alternative embodiment, the content for the formatted print pages is in an e-doc (as described above).

The proprietor of the web site makes material available to the information processor as necessary and appropriate (for example, if that material is not already available directly on the web site in a resolution suitable or optimized for printing) (step S204). In the current example, the web site offers products to their visitors or subscribers. In case the user indicates that he has a printer capable of creating, for example, a bound, printed version of a virtual document, then an electronic version suitable for producing the bound, printed version at the consumer's location, such as at home, is preferably provided.

A visitor/subscriber orders a product and implicitly or explicitly indicates that the visitor wants to print it on his or her own printer (step S206). Preferably, the web site detects that such a printer is attached to the visitor's computer, and offers this as an option. Also, the web site optionally remembers that the visitor has such a printer and has expressed such a present, either by recording this information in a database or in a cookie or equivalent file on the visitor's own computer.

At step S208, a determination is made whether this is the first time a particular product is ordered by the user, previously used ordering details are sent automatically to the information processor (step S210).

In an alternative embodiment, previously used ordering details are saved on information processor, thereby eliminating the need to transmit previously used order details each time a request for formatted print pages to be produced on a home printer is made.

If, in the alternative, in step S208, a determination is made that this is the first time a request for formatted print pages to be provided on a home printer is made by this user, the process branches to step S212 and information regarding the user's home printer is received by the information processor. Preferably, the user simply selects from a list of printers, and information regarding the respective printer is automatically referenced by the information processor.

After information regarding the user's printer is received (step S210), or the user has previously ordered formatted print pages, the process branches to step S214.

At step S214, the information processor locates the appropriate material on the web site or on the web site's server (or wherever else it is located) and automatically or with human intervention reformats it so that it can be automatically printed in the correct layout, order, or the like, on such a printer.

The information processor stores the reformatted version of the material for reuse the next time the identical item is ordered (step S216). At step S218, the process ends.

In the embodiment of the present invention in which the user indicates that he has a printer capable of creating the bound, printed version, the information processor sends the reformatted version of the material electronically to the web site for forwarding to the web site visitor. Alternatively, the information processor sends the reformatted version of the material directly to the web site visitor. Also, as supported by accompanying technology, the information processor preferably sends the reformatted version directly to the web site visitor's computer in such a way that, with the visitor's consent, printing begins immediately.

Optionally, once an item has been reformatted, the information processor sends the reformatted version to the web site, which then fulfills such requests without any involvement on the part of information processor.

Optionally, if there are several such home printers with different formatting requirements, the information processor saves an intermediate, printer-independent version of the material from which the different formatted versions can be generated, as well as the fully formatted version for the first visitor's particular home printer. Thereafter, as different visitors with different such home printers order the same item, the information processor produces the printer-specific version by starting with the printer-independent version, rather than having to start from the very beginning of the process. Furthermore, the information processor stores (and, optionally, provides to the web site) the printer-specific version for each printer for which a copy has been ordered.

Moreover, the information processor is able to create a printer-independent version of some or all items before any order or the information processor is able to create printer-specific versions of some or all items before any order.

Thus, the present invention reduces or eliminates the work associated with preparing electronic content for printing on consumer printing devices, which is not a trivial task. Centralizing and automating the process as much as possible relieves a great deal of burden on individual web sites.

Additional features of the present invention are described below.

One or more individuals associated with a web site create a file representing a document to be printed in bound, magazine-like format. This file may be wholly or partially print-ready.

The file is sent to a central site along with requested characteristics of the final output, such as thickness and finish of the cover and the interior paper, as well as information identifying allowing communication with the originators of the file.

At the central site, the file is examined by one or more experts to determine its readiness for printing, the amount and cost of work remaining to be done to render it optimally print-ready, the characteristics of the printed product such as number of pages, the per-copy cost, and the like.

On the basis of the evaluation, a communication is electronically transmitted to the party who sent the file, and the communication includes an estimate of the cost to make the file optimally print ready, the per-copy cost, and other terms and conditions of the business relationship to be established.

The originator of the document accepts or declines the costs and agrees to the terms and conditions of the business relationship.

If necessary, a software program and instructions are sent to the originator to enable the web site to transmit requests for the document.

The central site determines one or more appropriate print service providers for the document.

The central site establishes a mechanism to accept print requests from the web site and redirect them to the appropriate print service provider. Alternatively, the central site provides a mechanism whereby the print request from the web site goes directly to appropriate print service provider.

On the first request from a web site for the document, or in anticipation of such a request, if the document is not already optimally print-ready, the central site does the work necessary to make the document optimally print-ready.

On the first request from a web site for the document, or in anticipation of such a request, the central site sends the print-ready electronic version of the document to the print service provider to fulfill the print request.

Once these additional capabilities are established, other processes for providing formatted print pages, as described in the pending U.S. patent application Ser. No. 10/671,194, are preferably performed.

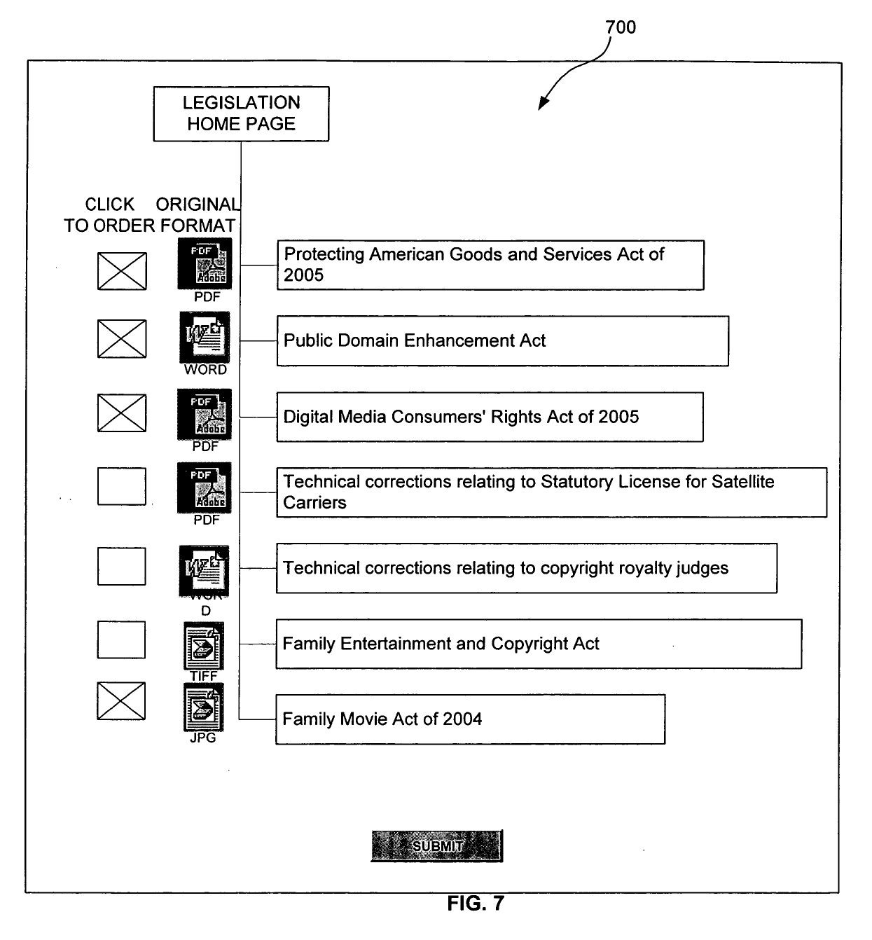

FIG. 7 illustrates an example interface 700 that is preferably provided by the present invention when a user requests formatted print pages of content available in one or more Internet web sites.

When a visitor indicates that he or she is ready to request the printed version, a display of the structure of the web site (sometimes referred to in the art as a site map) (FIG. 7), is displayed, with the web pages that the visitor has visited being distinctively displayed as selected. The visitor can then deselect some of the web pages that he or she has visited and select some of the pages that he or she has not visited before completing the request.

The site map displayed for this purpose may further include a small depiction (sometimes referred to in the art as a thumbnail) of each web page (not shown), to help the visitor make the selection.

If the web site includes virtual documents displayable using a document browser such as Acrobat Reader, the thumbnail preferably depicts the first page of the virtual document. An option is provided to enable the visitor to toggle between a site map showing thumbnails, and a site map without showing thumbnails.

If the site map is in the mode in which it does not display thumbnails, the visitor can request and view a thumbnail of a single selected element on the site map.

Each web page on the web site includes an icon, checkbox, radio button, or other graphic screen control providing a convenient mechanism that allows the visitor to indicate whether a particular web page is to be included among the web pages to be selected in a request for formatted print pages.

That selection is set to “yes” by default for all web pages, with certain exceptions.

A system user can set the selection of certain web pages (such as the site map itself) to “off” by default.

The system recognizes certain web pages (such as the site map itself) and sets the selection to “off” without requiring any action on the part of system user or web site visitor.

If a web page includes links to virtual documents that are displayable via a document browser, such as Adobe Reader, an indicator is provided as to whether or not a web page is to be included as formatted print pages appears in the document browser itself.

If a web page includes links to virtual documents that are displayable via a document browser, such as Adobe Reader, an indicator is provided as to whether or not the virtual document is to be included as formatted print pages appears next to (or is otherwise visually associated with) the link to the virtual document or icon representing the virtual document that invokes the browser. (In the case of a virtual document displayed via a document browser, the indicator refers to the entire document, rather than only the page under display, even if the web site visitor does not view each page of the virtual document.) Preferably, the visitor can visit the site map at any time during his or her session at the web site.

Moreover, the visitor can save his or her preferences for display of the current state of the site map specifications regarding what is to be printed. The user can close the session with the web site, and have those preferences and specifications retained and available the next time he or she visits the web site.

The system can retain the visitor's specifications for formatted print pages of the web site whether or not the user has registered, logged in and is known to the web site.

In a preferred embodiment, if the visitor has registered with and logged into a web site, the system retains these specifications in the system's database or in a database associated with the web site.

Whether or not the visitor has logged in, the system retains these specifications by writing the information in a file (sometimes referred to in the art as a cookie) on the visitor's computer.

The visitor can request a subscription to the requested portions of the web site, based on section titles or other distinguishing elements.

The subscription can be based on time period or on the content of one or more specified sections changing.

Further functionality of the present invention is described below. The following features of the invention are optional but preferable.

The system preferably recognizes the material appropriate to be included in formatted print pages as opposed to elements that should be excluded, such as headers, footers, navigation bars, or the like. If the web site is created using an automated web site management system that includes a database, the system user can specify particular elements to include and particular elements to exclude by a reference to the source of the elements in the database, or by various forms of naming conventions, or the like.

If a web site is not created using an automated system, the system user can visit each web page and indicate (using a variety of pointing devices, such as an outlining tool) one or more elements to include or to exclude.

The system itself can automatically decide what elements to include and what elements to exclude from each page by comparing the web page images to one another and deciding on the basis of which elements vary from web page to web page.

If the system automatically decides what elements to include or exclude, the system user can review those decisions and selectively override them.

The system user can specify fonts, font sizes, page headers and footers, and other standard formatting aspects to be applied to or selected elements of the bound, printed version of the web site.

The system user can specify the arrangement and contents of standard printed pages, such as front and back covers, inside front covers, title pages, or the like.

The system user can indicate variable content, such as copyrights, copyright dates, issue dates, or the like, and where such information is extracted from the web site itself or from a database, server, or the like.

The system user can specify whether certain standard elements are to begin on a right-hand or left-hand printed page.

By default, the title page and the first page of content both begin on right-hand printed pages.

The system user can specify globally or selectively whether web pages are to begin on a new printed page, begin on a new right-hand printed page, or begin on a new left-hand printed page.

The system user can make such specifications based on the level of each web page on a hierarchically arranged depiction of the web site, such as an outline or a site map.

The system user can make such specifications based on characteristics of the source of the web page, such as location in a database, a flag or other indicator in a database, narning conventions, or the like.

By default, each web page begins on a new printed page.

The system user can indicate globally or on a selective basis whether advertising displayed on the web site is to be included in the printed version.

The system user can specify what printable equivalent is to be printed when an animation (such as an animated advertisement) is displayed on a web page.

The system user can specify elements not appearing anywhere on the web site such as advertisements or other special material to be added to the printed version at specific locations, such as on the inside front cover, inside back cover, outside back cover, and the like.

The system user can specify the locations of such elements, and the system can automatically select the advertisements or other such special material is to be appear, based on information from another source, such as a database of advertisements and a specification of their schedule, frequency, geographical destination, web site visitor address, and the like.

The system can insert or other special material advertisements in locations specified by the system user based on demographic or other relevant information about the web site visitor based on his name, probable sex (based on name), address, ZIP code, previous buying habits, other information of any kind, including information in other databases.

The visitor can request an edition of the document without advertisements or with a smaller number of advertisements in exchange for a higher price or other special consideration.

The system automatically creates a table of contents from the titles of the selected web pages, virtual documents, and other selected elements.

The system provides a preview of the bound, printed version (i.e., formatted print pages) to the web site visitor.

The web site visitor can delete or rearrange virtual pages on the preview.

The web site visitor can delete specific elements from pages of the virtual document on the preview.

The system user can specify certain elements (such as logos, authors' names, copyright notices, advertisements, or the like) as not being able to be deleted by the web site visitor.

The system user can specify an entire section of material as not being editable by the web site visitor.

The system user can specify a series of pages of the virtual document as not rearrangeable by the web site visitor.

The system can automatically recognize certain elements (such as logos, copyright notices, advertisements, and material specifically inserted by the system user), and automatically make them not able to be deleted by the web site visitor.

By default, the system makes advertisements and other such special material not deletable by the web site visitor.

The web site visitor can make formatting changes to the preview, such as changing font, font size, inserting page breaks, or the like.

The system automatically adjusts the table of contents based on the changes made by the web site visitor.

The system user can specify whether advertisements or other special material is to be inserted into locations on printed pages that would otherwise be blank, such as at the bottom of the last printed page of the printable version of a web page. (Such advertisements or special material are known as “spot” advertisements. Although the term “spot advertisement” is used, this is understood to mean advertisement or other special material.)

The system user can specify the source of such spot advertisements.

The system automatically selects spot advertisements on the basis of best fit, priority, or other criteria specified by the system user.

The system calculates whether extra printed pages will have to be inserted. Such extra printed pages may include verso printed pages after successive printed pages specified as right-hand printed pages and extra printed pages necessary to make the total number of finished printed pages a multiple of four. If so, the system inserts advertisements or other special material as specified by the system user.

The system user can specify how and from what material the advertisements or other special material is to be selected by the system to be printed on inserted printed pages.

The system user can specify whether the preview displayed to the visitor shows the advertisements or other special material to be printed, shows an indicator that an advertisement or other special material will appear, or leaves such pages or other sections of the virtual document blank.

The system user can specify that all or some of the locations or printed pages are not to be filled with advertisements if the visitor is willing to pay a higher price or for other special consideration.

The system user can specify which advertisements are or are not to appear in such an edition.

When the visitor completes his or her specification, the order is transmitted for fulfillment.

The order includes sufficient information for the creation of the bound, printed version (i.e., formatted print pages) specified by the web site visitor, as well as information sufficient for fulfilling the order, such as the name and address of the recipient.

Upon receipt of the order, the formatted print pages are assembled by retrieving from its own database or that of the web site the appropriate elements indicated by the order specifications.

As appropriate, advertisements or other special materials are inserted onto the inserted pages, if they have not already been done so in the preview displayed to the web site visitor.

The system preferably tracks how many times each advertisement is printed, where it was printed within the printed version (for example, inside front cover, facing the title page, facing the first page of content, inside back cover, back cover, or the like), when it was printed, to whom it was sent, the demographic and other particulars of the people to whom it was sent, or the like.

The system makes such information easily available to the system user, as well as exportable to or otherwise accessible by other automated systems for billing, accounting, and other purposes.

To the greatest extent possible, the final printing and fulfillment is done automatically and programmatically, with minimal or no human intervention.

The system includes provision for a human operator (an operator of the portion of the system associated with the fulfillment process, preferably not the system user associated with the web site) to review the final version of the printable document in virtual form immediately before it is actually printed and to make adjustments as necessary, desirable, or appropriate.

The system user can specify a minimum number of extra pages for advertisements or other purposes to be inserted into the printed product, even though they are not necessary for purposes of forcing right-hand or left-hand pages or making the number of finished pages to be a multiple of four.

The system user can specify the locations of such extra pages by absolute or relative positions within the printed product. For example, insert a minimum of ten pages after the inside front cover; insert a minimum of five pages just after the table of contents and before the first item from the web site; insert ten pages just before the inside back cover.

The system interface provides a convenient graphical system by which the system user can make such specifications.

Such specifications are remembered by the system for subsequent productions of similar items from the same web site.

At the system user's preference, the end portion of material (such as a web page) that does not completely fill a single page (known familiarly as the “jump”) can be treated as such material is treated in a conventional magazine, by being arranged in one or more column and printed on a page, optionally with other such continuation material, later in the printed product, along with “continued on” and “continued from” indicators, added by the system and automatically adjusted.

The system user can place such jump material on pages for this purpose using a convenient graphical interface.

The system can place such jump material on pages for this purpose automatically.

The system can algorithmically attempt to fill as much of a single page with jump material.

The system can place each piece of jump material on a separate page.

The system user can rearrange automatically placed jump material using a convenient graphical interface.

The portion of a jump page not filled with jump material can be filled with advertisements specifically provided by the system user for this purpose.

The portion of a jump page not filled with jump material can be filled with filler material such as cartoons or other material specifically provided by the system user for this purpose.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A method for providing formatted print pages of electronic material in response to a request initiated by a user, the method comprising:
providing to the user a virtual document, the virtual document including at least one formatting instruction that affects the appearance of the virtual document;
receiving an electronic request from the user for the formatted print pages, wherein the electronic request includes electronic order information, and the formatted print pages are based on the virtual document;
processing the electronic order information to provide electronic production information representing instructions for fulfilling the request;
transmitting the electronic production information to a fulfillment facility;
generating the formatted print pages by the fulfillment facility; and
providing the formatted print pages to the user from the fulfillment facility.

2. The method of claim 1, wherein the virtual document is provided in a software application, and the software application includes a control operable for the user to initiate the electronic request.

3. The method of claim 1, wherein the step of providing to the user a virtual document is performed by a first software application, and the step of processing the electronic order information is performed by a second software application.

4. The method of claim 1, wherein the virtual document is at least one of an e-book, an e-doc, a word processing document, a spreadsheet file, an image file, and an ADOBE ACROBAT Portable Document Format.

5. The method of claim 1, further comprising receiving the electronic request once from the user, and using information in the electronic request for future electronic requests for formatted print pages.

6. The method of claim 1, wherein the electronic ordering information includes payment information from the user.

7. The method of claim 6, further comprising processing a payment represented by the payment information by the fulfillment center.

8. The method of claim 1, wherein the steps of receiving the electronic request, processing the electronic order information and transmitting the electronic production information are performed by a central server.

9. The method of claim 8, wherein the central server does not perform the steps of providing to the user the virtual document, and does not perform the step of generating the formatted print pages.

10. The method of claim 1, further comprising assigning rights to a system user for specifying particular formatting instructions for the formatted print pages.

11. The method of claim 10, wherein the system user specifies at least one of a font, point size, cover page, title page, positioning of elements in the formatted print pages, and advertising content.

12. The method of claim 10, further comprising providing to the user a preview of the formatted print pages.

13. A method for providing electronic information suitable for generating formatted print pages of electronic material in response to a request initiated by a user, the method comprising:
providing to the user a virtual document, the virtual document including at least one formatting instruction that affects the appearance of the virtual document;
receiving an identifier of a printing device from the user;
receiving an electronic request from the user for the formatted print pages, wherein the electronic request includes electronic order information, and the formatted print pages are based on the virtual document;
processing the electronic order information to provide electronic production information representing instructions for fulfilling the request;
transmitting the electronic production information to the user;
generating by the user the formatted print pages as a function of the transmitted electronic production information.

14. The method of claim 13, wherein the step of processing the electronic order information comprises translating converting display values representing colors to printer values.

15. The method of claim 14, wherein the display colors are formatted as red, green and blue, and the printer values are formatted cyan, magenta, yellow and black.

16. A method for providing formatted print pages of electronic material provided on an Internet web site in response to a request received over a communication network initiated by a user, the method comprising:
providing to the user a plurality of virtual documents, the virtual documents including at least one formatting instruction that affects the appearance of the virtual documents;
providing to the user a site map representing the web site, wherein the site map includes at least a list of at least one of the virtual documents and at least one control enabling the user to select at least one of the virtual documents for ordering formatted print pages;
receiving an electronic request from the user for the formatted print pages, wherein the electronic request includes electronic order information;
processing the electronic order information to provide electronic production information representing instructions for fulfilling the request;
transmitting the electronic production information to a fulfillment facility;
generating the formatted print pages by the fulfillment facility; and
providing the formatted print pages to the user from the fulfillment facility.

17. The method of claim 16, wherein the site map includes a thumbnail image representing the format of a selected virtual document.

18. The method of claim 16, wherein the site map includes a thumbnail image representing a selected virtual document.

19. The method of claim 16, wherein the site map includes a thumbnail image representing a web page where the selected virtual document can be displayed.

20. The method of claim 16, wherein all virtual documents in the site map are pre-selected.

21. The method of claim 16, wherein the site map can be displayed in various ways according to preferences of the user.

22. The method of claim 21, wherein the user's preferences are saved and specifications for displaying the site map are retained for future use.

23. The method of claim 22, wherein the user's preferences are substantially automatically applied when the user logs into the web site.
